(19) United States
(12) Patent Application Publication
(10) Pub. No.: US 2012/0036703 A1
(43) Pub. Date: Feb. 16, 2012

(54) MANUFACTURING METHOD OF PEN HAVING A SOLID STATE LEAD

(76) Inventor: Eun-Sung Lee, Seoul (KR)

(21) Appl. No.: 13/196,595

(22) Filed: Aug. 2, 2011

(30) Foreign Application Priority Data
Aug. 13, 2010 (KR) 10-2010-0078429

(51) Int. Cl. B23P 17/04

(52) U.S. Cl. 29/530

(57) ABSTRACT

The present disclosure relates to a method of manufacturing a pen that feels good when writing and has a solid state lead not causing collapsing or bending thereof, and particularly, to a method of manufacturing a solid state lead pen so that a solid state lead extracted from or inserted into a pen has an elegant appearance and excellent transparency. Disclosed is a method of manufacturing a solid state lead pen including: filling the inside of a body with a solid state lead material; attaching a handle assembly to the body to immerse a holder of a screw attached to the inside of the handle assembly into the solid state lead material; extracting a half solidified solid state lead to the outside of the body; solidifying the half solidified solid state lead extracted to the outside of the body; and inserting the solidified solid state lead into the body.

### CROSS-REFERENCE TO RELATED APPLICATION

This application claims priority to Korean Patent Application No. 10-2010-0078429, filed on Aug. 13, 2010, and all the benefits accruing therefrom under 35 U.S.C. §119, the contents of which in its entirety are herein incorporated by reference.

### BACKGROUND

1. Field

The present disclosure relates to a method of manufacturing a pen that feels good when writing and has a solid state lead not causing collapsing or bending thereof, and particularly, to a method of manufacturing a solid state lead pen so that a solid state lead extracted from or inserted into a pen has an elegant appearance and excellent transparency.

2. Description of the Related Art

FIG. 1 is a conceptual diagram illustrating a procedure of manufacturing an existing solid state lead pen.

As shown in FIG. 1, a solid state lead pen 100 includes: a handle 20 that is rotated by a user, a body 11 that supports a solid state lead 13S positioned therein, a screw 21 that extracts the solid state lead 13S received inside the handle 20 to the outside of the body 11 or inserts it into the body 11, and a cap 15 that opens and blocks an entrance of the body 11.

As a method of manufacturing the solid state lead pen 100 with the above-described configuration, the handle 20 and the body 11 are assembled, and the screw 21 is inserted into the body 11 so that the screw 21 is fastened to the handle 20.

Then, a nozzle 1 ejecting the solid state lead material 13L is inserted into the body 11, and the solid state lead material 13L is ejected through the nozzle 1. Subsequently, a holder 23 formed at the upper end of the screw 21 is filled with the solid state lead material 13L, and the inside of the body 11 is filled with the solid state lead material 13L as the ejection amount increases.

When the solid state lead material 13L is filled up to the entrance of the body 11, the body 11 is covered by the cap 15 after stopping the ejection and moving the nozzle 1. When the solid state lead material 13L is air-cooled in this state, the solid state lead material 13L filled in the body 11 is solidified.

In order to use the solid state lead pen 100 manufactured in this manner, the user removes the cap 15 and rotates the handle 20 while holding the body 11 by one hand. Accordingly, the screw 21 rises, so that the solid state lead 13S fixed to the holder 23 of the screw 21 is pushed up by the screw 21. The user may write a letter or draw a picture by using the solid state lead 13S extracted to the outside of the body 11. When the user wants to stop using the solid state lead pen 100, the user rotates the handle 20 to insert the extracted solid state lead 13S into the body 11 and manages the solid state lead pen by covering it with the cap 15.

Meanwhile, when the solid state lead material 13L is filled in the body 11 and is solidified in an air-cooling condition, the solid state lead material 13L is solidified while being fixed to the inner surface of the body 11. When the solid state lead 13S solidified in this manner is pushed up, a part of the solid state lead 13S fixed to the inner surface of the body 11 is stretched and cut, so that there are problems in that the outer surface of the solid state lead 13S is not elegant and the stretched portion has a shape in which it flows down along the solid state lead 13S.

Furthermore, when the solid state lead 13S and the body 11 are strongly fixed to each other, there is a problem in that an erroneous operation occurs in which the solid state lead 13S is not extracted due to the idle rotation of the screw 21 or the solid state lead 13S is deformed even when it is extracted.

Furthermore, the solid state lead 13S is formed to be transparent, but there is a disadvantage in that the transparency is degraded due to the discoloration of the stretched portion as described above.

In order to solve such a disadvantage, lubricant is applied into the body 11 to for a lubricating layer before the filling of the solid state lead material 13L, and the solid state lead material 13L is filled therein.

However, there are disadvantages in that a lubricant supply facility and a lubricant application facility need to be provided for the lubricating layer and the solid state lead pen manufacturing process becomes complicated due to the additional lubricant application step.

Furthermore, since the lubricant flows down when the lubricant is applied while the body stands, there is a disadvantage in that the outer surface of the solid state lead is uneven due to the lubricating layer.

Moreover, there is a disadvantage in that the transparency of the solid state lead is degraded due to the lubricating layer.

### SUMMARY

The present disclosure is directed to providing a method of manufacturing a solid state lead pen so that an outer surface of a solid state lead is elegant and transparency of the solid state lead is excellent even when a lubricant application process is not provided.

In one aspect, there is provided a method of manufacturing a solid state lead pen including: filling the inside of a body with a solid state lead material; attaching a handle assembly to the body to immerse a holder of a screw attached to the inside of the handle assembly into the solid state lead material; extracting a half solidified solid state lead to the outside of the body; solidifying the half solidified solid state lead extracted to the outside of the body; and inserting the solidified solid state lead into the body.

The half solidified solid state lead may be extracted to the outside of the body after 25 to 35 minutes are elapsed from the time when the inside of the body is filled with the solid state lead material.

One side of the body may be opened, and a cap may be attached to the opened one side so that one side of the body may be opened and blocked by the cap.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a conceptual diagram illustrating a procedure of manufacturing an existing solid state lead pen;

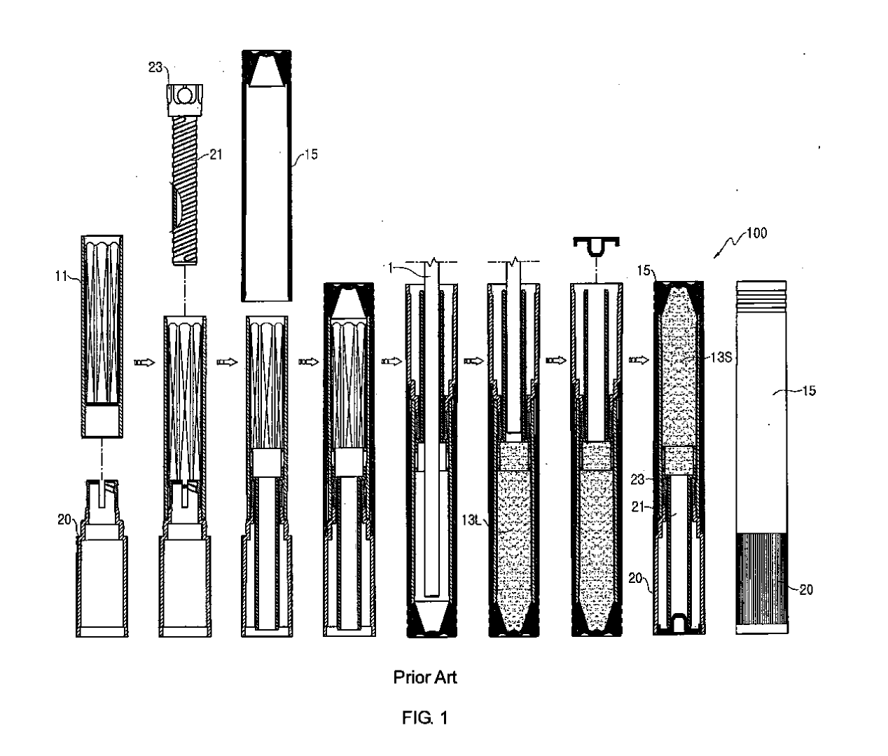

FIG. 2 is a conceptual diagram illustrating a procedure of manufacturing a solid state lead pen according to one embodiment of this disclosure; and

FIG. 3 is a side view illustrating the manufactured solid state lead pen.

### DETAILED DESCRIPTION

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals denote like elements. The shape, size and regions, and the like, of the drawing may be exaggerated for clarity.

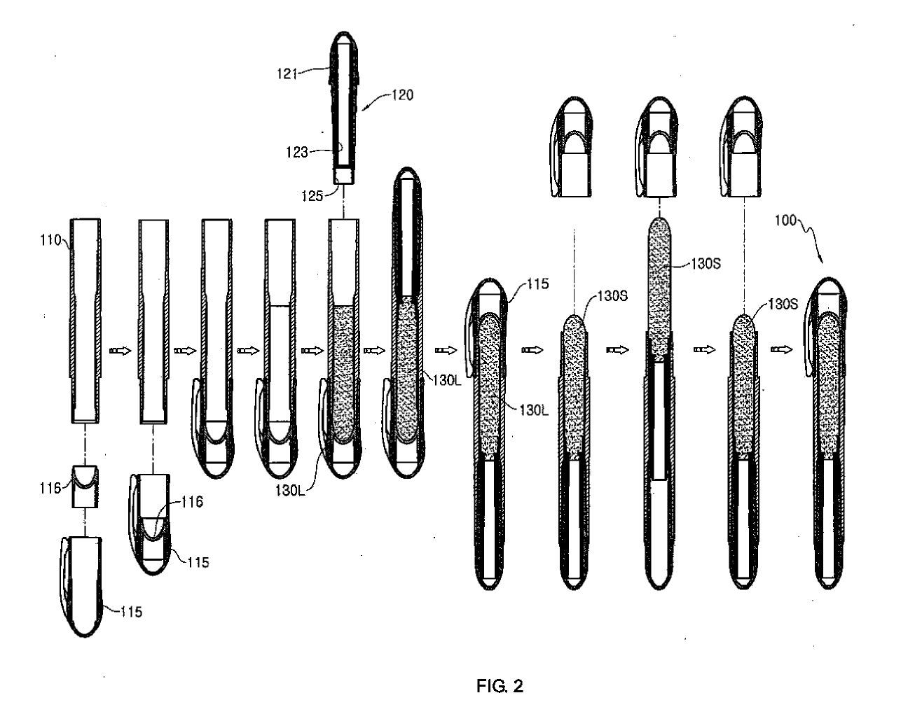

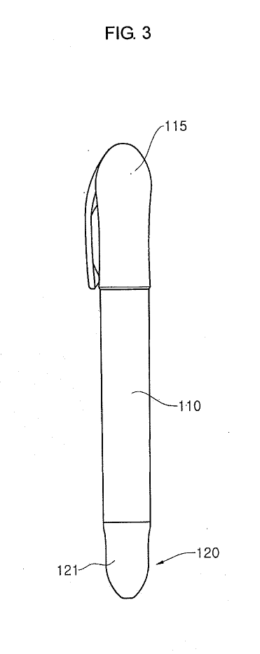

In the drawings, FIG. 2 is a conceptual diagram illustrating a procedure of manufacturing a solid state lead pen according to one embodiment of this disclosure, and FIG. 3 is a side view illustrating the manufactured solid state lead pen.

As shown in FIGS. 2 and 3, a solid state lead pen 100 includes: a cylindrical body 110, a cap 115 that blocks an entrance at one side of the body 110, and a handle assembly 120 that is attached to the other side of the body 110 and is used to extract a solid state lead 130S positioned inside the body 110 to the outside of the body 110 or insert it into the body 110. When the solid state lead 130S is fixed to the handle assembly 120 and the handle 121 of the handle assembly 120 is rotated, the solid state lead 130S is extracted to the outside of the body 110 or is inserted into the body 110 by an inner screw 123.

Then, an inner cap 116 is fixed to the cap 115. When the inside of the body 110 is filled with a solid state lead material 130L while the entrance of the body 110 is blocked by the cap 115, the distal end of the solid state lead material 130L is molded in a shape according to the shape of the inner cap 116.

Hereinafter, a method of manufacturing the solid state lead pen with the above-described configuration will be described.

As shown in FIG. 2, the method of manufacturing the solid state lead pen 100 includes: attaching the cap 115 to the body 110 to block the entrance of the body 110; filling the inside of the body 110 with the solid state lead material 130L from the other side thereof while the entrance of the body 110 is blocked; fastening the handle assembly 120 to the other side of the body 110 to immerse a holder 125 of the screw 123 into the solid state lead material 130L; opening the cap 115 and rotating the handle 121 of the handle assembly 120 to extract the solidifying solid state lead 130S to the outside of the entrance of the body 110; solidifying the solid state lead 130S; inserting the solidified solid state lead 130S into the body 110 after the solid state lead 130S is solidified in the extracted state; and blocking the entrance of the body 110 using the cap 115.

Hereinafter, each of the steps of manufacturing such a solid state lead will be described in detail.

One side of the cylindrical body 110 is an entrance, and the other side thereof is attached with the handle assembly 120. The cap 115 is attached to the entrance of the body 110 to block the entrance of the body 110.

The inner cap 116 is positioned inside the cap 115 and the cap 115 is attached to the body 110 while the inner cap 116 faces the entrance of the body 110.

The inside of the body 110 is filled with the solid state lead material 130L through the other side of the body 110 while the entrance of the body 110 is blocked by the cap 115. The solid state lead material 130L has fluidity in the form of gel. When the inside of the body 110 is filled with a predetermined amount of the solid state lead material 130L, the material 130L is filled therein according to the shape of the inside of the body 110 and the inner cap 116.

Then, the handle assembly 120 is attached to the other side of the body 110. The handle assembly 120 includes the handle 121 that is rotatably coupled to the body 110, the screw 123 that is positioned inside the handle 121 and is threaded into the inner surface of the handle 121, and the holder 125 that is formed at one end of the screw 123 and is coupled to the solidified solid state lead 130S. When the handle assembly 120 with the above-described configuration is attached to the other side of the body 110, the screw 123 advances into the body 110, and the holder 125 is immersed into the filled solid state lead material 130L.

In this state, the solid state lead material 130L is solidified as time goes by, but the hardness thereof does not increase any more after 40 to 50 minutes due to the characteristics thereof. When the solid state lead material 130L is completely solidified after 40 to 50 minutes at an air-cooling condition, a part of the outer surface of the solidified solid state lead 130S is fixed to the inner surface of the body 110. Accordingly, in this disclosure, the handle 121 of the handle assembly 120 is rotated to extract the solid state lead 130S to the outside of the body 110 while the solid state lead 130S is half solidified.

The half solidified state of the solid state lead 130S indicates a state where the shape of the solid state lead 130S is formed, but the solid state lead 130S is slidable without being fixed to the inner surface of the body 110 due to a small friction thereof.

In this manner, when the half solidified solid state lead 130S is extracted to the outside of the body 110, since there is no portion fixed between the solid state lead 130S and the body 110, the half solidified solid state lead 130S is slid to the outside of the body 110.

Here, it reaches the half solidified state after 25 to 35 minutes are elapsed from the time when the inside of the body 110 is filled with the solid state lead material 130L. When the elapsing time is less than 25 minutes, the hardness of the solid state lead material 130L is low, so that the solid state lead material 130L may be deformed due to the own weight when it is pushed up out of the entrance of the body 110. When the elapsing time exceeds 35 minutes, it becomes a partially solidified state, so that some portions may be fixed to the inner surface of the body 110. Accordingly, the half solidified solid state lead 130S needs to be pushed out of the body 110 after 25 to 35 minutes are elapsed from the time when the inside of the body 110 is filled with the solid state lead material 130L.

In this manner, the half solidified solid state lead 130S is extracted to the outside of the body 110 and is cooled in atmosphere, so that the solid state lead 130S is completely solidified.

When the solid state lead 130S is completely solidified, the handle 121 is rotated to insert the solidified solid state lead 130S into the body 110, and the entrance of the body 110 is blocked by the cap 115.

In this manner, since the half solidified solid state lead 130S is completely solidified after it is extracted to the outside of the body 110, it is possible to prevent the existing problem in which the outer surface of the solid state lead is fixed to the inner surface of the body. Accordingly, this disclosure may solve the problems occurring when manufacturing the existing solid state lead pen, the problems corresponding to the uneven appearance of the solid state lead and the irregular transparency. Furthermore, since this disclosure does not need the application of lubricant, the manufacturing process may be shortened and the facility for the application of lubricant may not be needed.

Meanwhile, the method of manufacturing the solid state lead pen according to this disclosure relates to a method of manufacturing a material having characteristics in which it is solidified from a liquid state into a solid state, and a pencil, a glue, a crayon, a board marker, and the like having a core material such as a solid state lead may be easily manufactured by the method of manufacturing the solid state lead pen according to this disclosure.

As described above, in the method of manufacturing the solid state lead pen of this disclosure, since the solid state lead material filled in the body is extracted to the outside before it is solidified so as to be solidified in atmosphere, the solid state lead may be smoothly manufactured.

Furthermore, in the method of manufacturing the solid state lead pen of this disclosure, since the solid state lead material is not fixed to the inner surface of the body while the solid state lead is solidified, the transparency may be maintained.

Furthermore, in the method of manufacturing the solid state lead pen of this disclosure, since the solid state lead material is solidified while being extracted to the outside of the body and the solidified solid state lead is inserted into the body, the facility and the process for the application of lubricant are not needed. Accordingly, the facility and the manufacturing process are simple.

While the exemplary embodiments have been shown and described, it will be understood by those skilled in the art that various changes in form and details may be made thereto without departing from the spirit and scope of the present disclosure as defined by the appended claims.

In addition, many modifications can be made to adapt a particular situation or material to the teachings of the present disclosure without departing from the essential scope thereof. Therefore, it is intended that the present disclosure not be limited to the particular exemplary embodiments disclosed as the best mode contemplated for carrying out the present disclosure, but that the present disclosure will include all embodiments falling within the scope of the appended claims.

What is claimed is:

1. A method of manufacturing a solid state lead pen comprising:
filling the inside of a body with a solid state lead material;
attaching a handle assembly to the body to immerse a holder of a screw attached to the inside of the handle assembly into the solid state lead material;
extracting a half solidified solid state lead to the outside of the body;
solidifying the half solidified solid state lead extracted to the outside of the body; and
inserting the solidified solid state lead into the body.

2. The method according to claim 1, wherein the extracting of the half solidified solid state lead to the outside of the body is performed after 25 or 35 minutes are elapsed from the time when the inside of the body is filled with the solid state lead material.

3. The method according to claim 1, wherein one side of the body is opened, and a cap is attached to the opened one side so that one side of the body is opened and blocked by the cap.
